(19) United States
(12) Patent Application Publication
(10) Pub. No.: US 2009/0234611 A1
(43) Pub. Date: Sep. 17, 2009

(54) Method For Measuring The Position Of A Mark In A Micro Lithographic Deflector System

(75) Inventor: Peter Ekberg, Lidingö (SE)

Correspondence Address: HARNESS, DICKEY & PIERCE, P.L.C., P.O. BOX 8910, RESTON, VA, 20195, US

(73) Assignee: MICRONIC LASER SYSTEM AB, Taeby (SE)

(21) Appl. No.: 11/919,219

(22) PCT Filed: Apr. 25, 2005
(86) PCT No.: PCT/SE2005/000591

§ 371 Date: Mar. 31, 2009

(51) Int. Cl. G06F 19/00; G06F 15/00

(52) U.S. Cl. 702/95; 702/150

(57) ABSTRACT

The present invention relates to a method for determining the coordinates of an arbitrarily shaped pattern in a deflector system. The method basically comprises the steps of: moving the pattern in a first direction (X), calculating the position of the edge of the pattern by counting the number of micro sweeps, performed in a perpendicular direction (Y), until the edge is detected, determining a correction function for the surface reflecting variations in a third direction (Z) perpendicular to both the first (X) and the second (Y) directions, and determining the coordinates by relating the number of counted micro sweeps to the speed of the movement of the pattern using the correction function to compensate for variations in the third direction. The invention also relates to software implementing the method.

### TECHNICAL FIELD

The present invention relates to a method for determining the coordinates of an arbitrarily shaped pattern on a surface in a deflector system, as defined in claim 1 and 14. The invention also relates to software implementing the method for determining the coordinates of an arbitrarily shaped pattern on a surface in a deflector system, as defined in claim 22.

### BACKGROUND TO THE INVENTION

The method used for measuring time in a deflector system has been used many years. Almost no modifications in the algorithm have been done so far. Only the pattern used for different kinds of calibrations has been modified during the years. Today we have an experimental verified repeatability of the method in the range of 10-15 nm over a surface of 800×800 mm. The 10-15 nm means here the measurement overlay.

One drawback of the method used is that we so far only can measure in the same direction as the micro sweep. In order to measure an X-coordinate we therefore must use special patterns containing 45-degree bars.

The method according to prior art is briefly described, since it is important to understand the present invention.

It is difficult to measure time with high accuracy. If, for example, you want to measure a pulse with the resolution of 1 nanosecond (ns) you need a measurement clock with the frequency of 1 GHz if classical frequency measurement methods are used. In the described prior art system, there is no need to measure a single shot of a pulse. The use a scanning beam while measuring will get several one-dimensional images of a bar or several bars, as an example. Only the “average” position of an edge or the CD of a bar is interesting. The measurement system will only give an average result together with its sigma. It is important to remember that the measurement system is good enough if this sigma is lower that the natural noise in the system. This natural noise can be summarized to be laser noise, electronically noise and mechanical noise. The noise from the measurement system itself can be calculated theoretically or verified in practice with a known reference signal. It is also possible to get a figure of the measurement system noise by simulation. The measurement of the position of the bar or the CD will therefore contain the error:

Errorₜₒₜ=\sqrt{(Errorₙₐₜᵤᵣₐₗ)²+(Errorₘₑₐₛᵤᵣₑₘₑₙₜ)²}

When we measure time we use a so-called random phase method. What this means is that the measurement unit it-self is completely un-correlated in phase to the signal we want to measure. Due to the fact that the signal phase is random relative the measurement clock phase we can use a measurement clock frequency that is much lower and use an “averaging” effect instead to achieve the accuracy.

In FIG. 1 the measurement clock phase is shown relative the reference signal (SOS). Please note that the input signal (the bar) is synchronized with the reference signal since it is generated from the micro sweep itself. The upper row of clocks in FIG. 1 is the ruler marked in measuring clock increments. What we are after is where the positive going edge 10 of the input signal is relative our reference signal. Of course we also are interested of the negative going edge 11. But the same method may be used to find the position of any edge.

Let us call the period time of the measurement clock tm. Since the input signal is a result from the micro sweep we also know exactly the relationship between the pixel clock period in time and what that corresponds to in nanometers. Here we introduce tp for the pixel clock period in nanoseconds. We also call the pixel clock period in nanometers for pp. The scaling expression can therefore be expressed as:

$$pm ( nm ) = \frac{pp ( nm )}{tp ( ns )} \cdot tm ( ns )$$

pm is what each measurement clock period corresponds to in nanometers. From FIG. 1 we can see that the approximate position of the first edge, denoted 10, is 8 pixel clocks. Please note that by doing only one measurement i.e. using one of the six measurements 1-6 we can se that the edge is within the range of 8-10 measurement clocks. The accuracy is in other words 2*tm. Using above scaling expression this can be expressed in nanometers too.

In the following some realistic numbers are introduced.

tm=(1/40)=25 ns.
tp=(1/46,7)=21.413 ns.
pp=250 nm.

This results in that the pm=291.86 nm.

If we now count measurement clock ticks by resetting a counter by the reference signal we see that we only will count 8 or 9 ticks. No other count is possible in this example. The edge position relative the phase of the measurement clock will in this way be rectangular distributed inside tm. The average position can therefore be calculated just by adding counts from several measurements together and divide this number with number of measurements. In this example we get (8+8+8+8+9+9)/6=8.33 counts as an average value. So an estimation of the position of the edge can be calculated to be:

8.33×291.86=2432 nm.

Now it is not enough just to use 6 measurements as in this example. Normally you use several thousands of measurements. (In the detailed description, the three sigma of the average value is described from a theoretical point of view.)

Furthermore, no method has been disclosed that compensate for variations in thickness of the object when the coordinates of an arbitrarily shaped pattern, arranged on a surface of an object, is measured for calibration purposes in a deflector system.

### SUMMARY OF THE INVENTION

An object with the present invention is to provide a method for determining coordinates, especially in two dimensions, in a deflector system using any kind of pattern which compensate for the unevenness of the surface carrying the pattern.

A solution is achieved in the features as defined in claim 1 and 14.

Another object with the present invention is also to provide software for performing the method, which is provided in the features defined in claim 22.

An advantage with the present invention is that it is possible to generate an image of the pattern without using any other detection method than the one we already are using today, since the present invention is similar to the prior art method, except that it is 90 degrees rotated, with a better accuracy than prior art systems.

Another advantage is that no new hardware is needed since the present invention is implemented in software.

### BRIEF DESCRIPTION OF THE DRAWINGS

FIG. 1 illustrates the method for measuring time in the same direction as the micro sweep according to prior art.

FIG. 2 shows an image of the star-mark that could be used for measuring time and position according to the invention.

FIG. 3 shows an enlargement of a part of the image in FIG. 2.

FIG. 4 illustrates the principal measuring technique of a horizontal bar according to the invention.

FIG. 5 illustrates the principal measuring technique of a vertical bar according to the invention.

FIG. 6 illustrates the preferred method to obtain X-coordinate using a sweep in Y-direction according to the invention.

FIG. 7 shows an image obtained by using the method according to the present invention.

FIG. 8 shows an enlargement of the image in FIG. 7.

FIG. 9 shows cursors applied to the image presented in FIG. 7

FIGS. 10 and 10b show expanded views of the cursors in FIG. 9.

FIG. 11 shows a graph illustrating the average speed for a measurement.

FIG. 12a illustrates the statistic principle behind random phase measurement as is used in a preferred embodiment according to the invention.

FIG. 12b illustrates the exposure case.

FIG. 13 illustrates the plate bending effect for calculating an offset used in the present invention.

FIGS. 14a and 14b illustrate the plate bending effect a glass plate with a flat top and a shaped bottom and the introduction of a reference surface when arranged on a flat support.

FIGS. 15a and 15b illustrate the plate bending effect a glass plate with a shaped top and a flat bottom and the introduction of a reference surface when arranged on a flat support.

FIGS. 16a and 16b illustrate the plate bending effect a glass plate with a flat top and a flat bottom and the introduction of a reference surface when arranged on a shaped support.

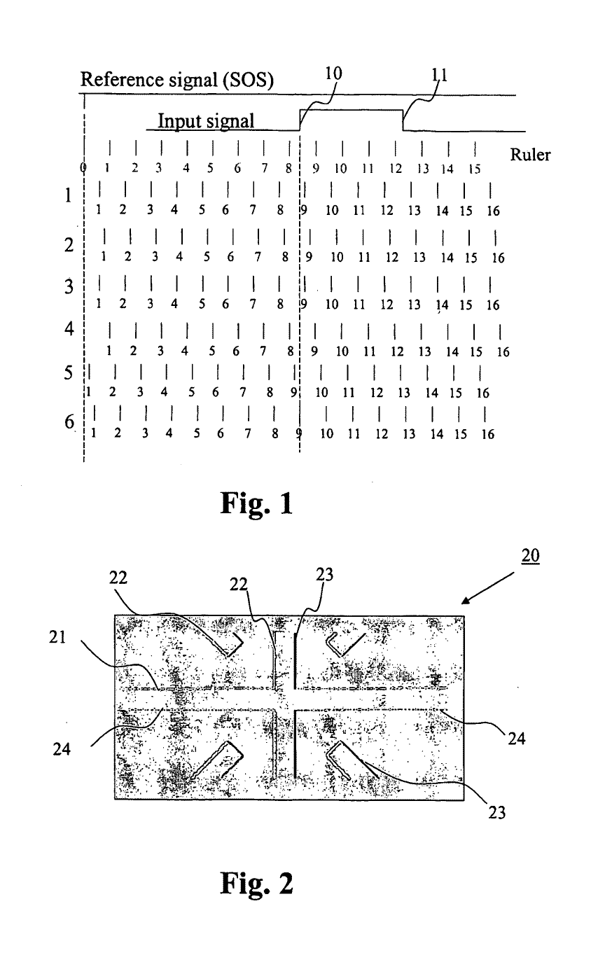

### DETAILED DESCRIPTION OF THE PREFERRED EMBODIMENTS

So far we only have used this method to measure along the micro sweep i.e. in one dimension. It is though possible to extend the method to measure in two dimensions. When we do this we actually are generating images of the pattern we measure.

When we talk about images we normally see this as a set of pixels. (Each pixel has a certain “gray-level” that describes the intensity of the pixel).

When handling CCD images each pixel is fixed in position in a certain raster (or grid). When analyzing a CCD image for finding the position of an edge both information of the pixel's location and gray-level must be used. Different straightforward methods may be used for estimating an edge position in the image. The accuracy of the position estimation depends in the calibration of the CCD array i.e. where the pixels are located in the array, how sensible they are for light and how well we can place the image on the array without any distortions. Light distribution over the CCD and different kinds of optical distortions will contribute to the error of the position estimation. A lot of these errors can be overcome if we calibrate the measurement system against a known reference.

When using the method according to the invention we also refer to pixels. But our pixels are not fixed in location in a certain grid. If we make a “snap shot” of the pattern by just measuring it once we will get information with a quite rough resolution (or accuracy). It is important to realize that the only information we are using is the pixels location. We do not use any gray-level information at all. Of course it is possible also to use gray-level information by recording the pattern using different “trig” levels in the hardware. This is what we do if we are interested in beam-shapes as in focus measurements. Here we only are interested in measuring the location of one or several bars so we can calculate center of gravity and CD.

When measuring registration and CD we never are interested in the exact location of one single pixel. Normally we only are interested in the average of several pixels location. In a CD measurement we use cursors to define number of pixels to be used in this average value. Also in the center of gravity estimation we use cursors to “even out” noise from the edge. This noise might be roughness from the pattern itself or noise in the measurement system. This is the same when using a CCD image as input.

In this suggested method we use the micro sweep itself as our light source (or ruler). It is hard to find a more accurate ruler than this. We already have methods to calibrate this ruler both in power and linearity very accurately.

In FIG. 2 we have captured an image 20 of a part of our star-mark. The image shows the location of pixels 21 in a grid of (316×250) nm. Nothing more than just showing the pixels in this grid has been done in the image. The image 20 shows so called events in the area. The mark has been scanned with a hardware cursor of 100 um. The positive going edges 22 are shown as white pixels and negative going edges 23 (chrome-glass transitions) are shown as black pixels. Just by observing this image you can see that the mark is slightly rotated counter clock vice. The number of black pixels in the lower Y-parallel bars 24 compared to whites ones is a clear indication of this fact.

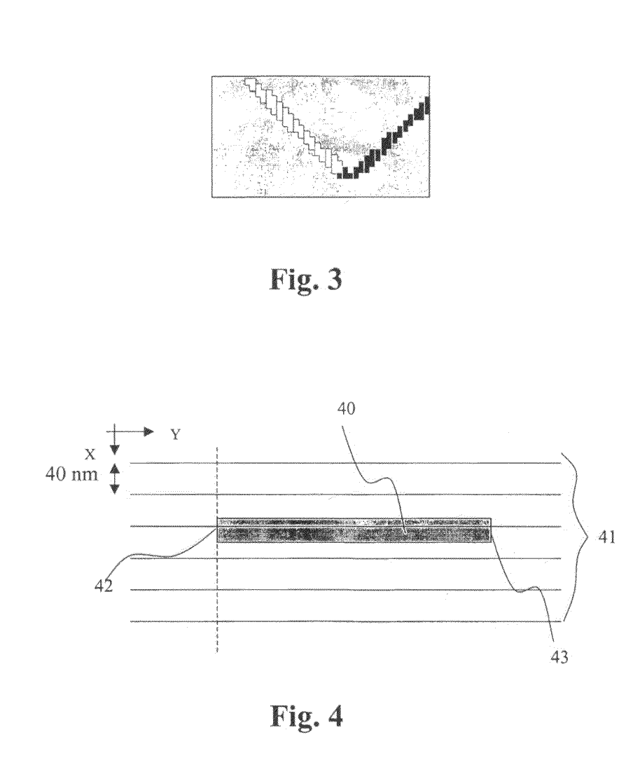

In order to demonstrate the actual grid we are using and how the pixels are distributed in this grid we refer to FIG. 3.

Here we have enlarged a part of the image 20. This “hard copy” of the image shows clearly where we have found events. The method to “sharpen” up this image will be presented below. The scale in this image is correct in that sense that one pixel is 316 nm in X-direction (vertical scale) and 250 nm in Y-direction (horizontal scale).

### Estimation of the X-Coordinate

As has been described in the background to the invention, there exists a very accurate method to estimate the Y-coordinate of an event. The micro sweep is used as a ruler and a measuring clock that is random in phase relative the ruler. The measurement clock will give us a rough resolution of tm (292 nm) in a single shot measurement. If we use several measurements and build us an average value we will get a much higher resolution (see below). Actually we can choose the accuracy just be selecting number of measurements and the length of the cursor to be used. So far this is true for the estimation of the Y-coordinate. The problem is how do we do to estimate the X-coordinate?

Obviously it is difficult to believe that it is possible to get an X-value out from data retrieved by a scanning a beam in Y-direction. The big step forwards is that it actually is possible to retrieve this information almost with the same accuracy as the Y-coordinate. But to get it we must introduce another signal (that actually already is used in the system), the lambda/2 X-signal.

In the prior art, when measuring a 45-degree bar of a pattern as in the star-mark case, we use the X-lamda/2 signal as “marks” in X-direction to define an X-cursor. Inside the cursor we also record the lamda/2 signal simultaneously when we count the measurement clocks. But since we measure on a 45-degree bar we actually are using only Y-information to get the X-coordinate. In combination with the lambda/2 information we can calculate the X-coordinate with a very high accuracy. The drawback of this method is of course that we are not able to measure on any kind of pattern. Especially we cannot measure on a bar that is parallel with the ruler. If we extend the method we already are using in Y-direction a little bit, we will soon realize that the problem to solve is exactly the same as we have in Y-direction but rotated 90 degrees. If we change our measurement clock to our reference signal (here the SOS—Start Of Sweep) and use the lamda/2 signal as reference instead we have rotated the problem 90 degrees.

When doing this “rotation” of the problem we need to re-calculate our parameters. In Y-direction our resolution was one measurement clock that corresponded to 292 nm. During one run over the pattern of interest we scanned it with a frequency of approximately 30 kHz. The question now is how far we move in X-direction between the scans. If we set the speed as low as possible we will retrieve about 8-10 scans of the pattern in each lambda/2 period. Since one lambda/2 period corresponds to 316 nm we have a resolution in the range of 30-40 nm in X-direction. This is because we scan the pattern with the frequency of 30 kHz during the movement in X-direction. Now when we use the lamda/2 signal as the reference we therefore have a “clock” with a spatial resolution of 30-40 nm in X-direction. This is significantly higher than the resolution in Y-direction. But, and this is important, we will not get as many samples in X-direction as in Y because of the movement in X. This fact is illustrated in FIG. 4.

The situation in X-direction is shown in FIG. 4. A bar 40 is scanned in one stroke (run) and generates one event only in the six scans 41. So when moving over the bar one time we know the position of the bar with an accuracy of +/−40 nm in the X direction. The Y-coordinate of the bar location is known with the accuracy of +/−292 nm (in each of the two edges 42 and 43). In FIG. 4, the CD in X-direction of the bar is lower than the 40 nm measurement grid we use in X-direction. So just running one time over the pattern might miss the fact that there is a bar at all.

This is natural since the resolution is lower than the CD of the bar to be measured. In order to measure the bar with higher resolution you need to do several runs over the pattern with random phase.

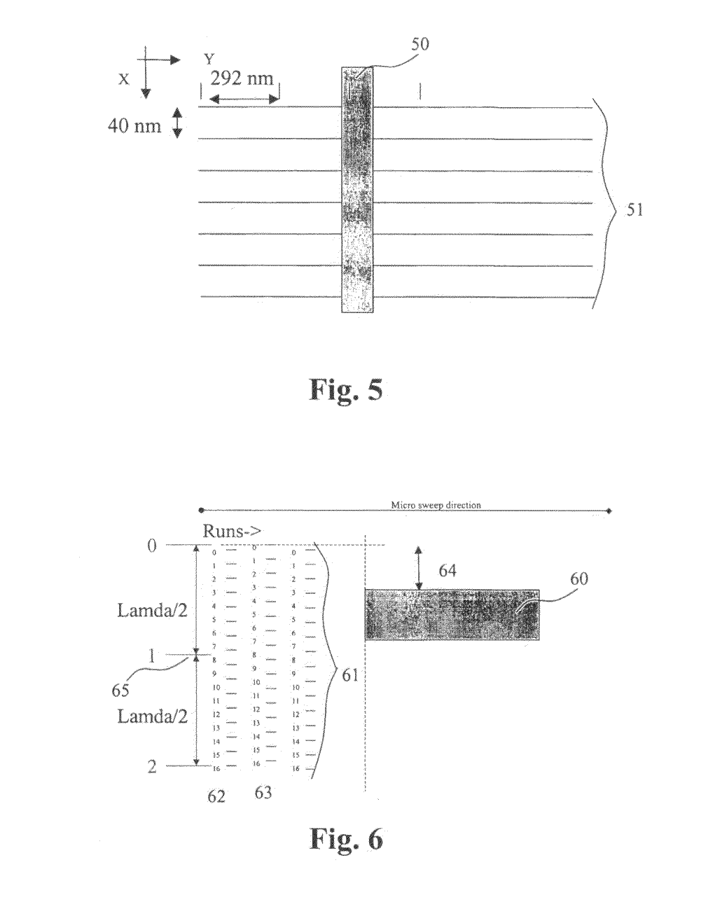

A comparison of the situation in Y-direction is illustrated in FIG. 5. Here you are scanning a bar 50 with the same length in Y-direction. The resolution in Y-direction in each scan 51 is 292 nm but you retrieve 7 scans over the same length of the bar.

If we separate the problem we can say that in one scan we can resolve a pixel with the resolution 40 nm in X-direction and 290 nm in Y-direction.

### The Algorithm.

So far we have described the main principle in Y and X direction. We have rotated the problem in Y 90 degrees to X. In Y-direction we have two processes that are random relative each other, the measurement clock and the SOS (or any correlated signal to SOS). In X-direction the measurement clock corresponds to the SOS signal and the reference is the lamda/2 signal. Also these signals (or processes) are un-correlated. We have different resolution in the different directions but it turns out that the accuracy is almost the same.

In FIG. 6, the principle of how to get the X-coordinate of a bar 60 is described. In FIG. 6 we see a bar 60 that is parallel with the ruler and micro sweep direction. The reference signal is the lambda/2 positions. In each lamda/2 interval we scan the pattern 61 with the micro sweep (our ruler). The movement over the pattern in X direction is performed with a much lower speed compared to the speed used when exposing a pattern. In this example we get about 8 scans 61 in the lamda/2 interval. If we now start to count SOS in the interval we will have a very similar situation as described above. If we count the total number of scans in the interval this will be a measurement of the speed in the interval. Since we cannot assume that the speed is the same in all the intervals it is important to do this speed calculation in order to get the correct “weight” of an event in the interval in X-direction. In this example we will get a Y-event (a transition from glass to chrome) when we have counted two SOS in the first run 62, three in the second 63 and so on: So just adding the “index” of the event inside an interval and divide this number with total number of SOS in the interval will give us an estimation of the X-coordinate of an event inside a certain interval. Above we will get the approximate position of the first Y-event after three runs over the mark to be (2+3+2)/3=2.3 SOS tics in the interval. To calculate what this corresponds to in nanometers we just multiply this number with the local resolution.

Here we get 2.3*316/8=92.2 nm. This is the local coordinate 64 for the edge of the bar 60 in the first interval. The local resolution depends on the speed, i.e. total number of SOS in the interval. If we can run the system more slowly this resolution will be better. But you will also gain resolution by scanning the bar in several runs. Below, the accuracy of the average position estimation is discussed.

As can be seen from above discussion we actually can calculate the X-coordinate from data retrieved from a scanning sweep in Y-direction. What we do is using the fact that we know exactly where we are in X-direction every time we pass an interval border 65. Inside an interval we only must assume that the speed is constant. This of course does not mean that the speed needs to be constant over all intervals. In practice we run several times across the pattern in both directions and record the Y-events and lamda/2 positions simultaneously. We therefore have the possibility to calculate the local speed with high accuracy by using information from all the runs.

The method described above is suitable to be used in either a laser lithography system or an e-beam lithography system.

### Filtering

What we really are after is not the exact position of an individual pixel. The discussion so far has lead us to that the position accuracy of a single pixel depends of how many times we have recorded the pattern and the resolution we use during the recording. If we scan the pattern a certain number of times we can “select” the accuracy we want before hand. This can be done since we have full control over the measurement process. When we do this “accuracy” selection we also must consider our cursors. As have been mentioned before a cursor is just another way to define number of pixels to use for calculating an average value.

There are many ways to apply a filter to this kind of data. An obvious way might be to fit a line using standard regression techniques. These techniques works but does not generates the optimum result in this case. The main reason is that the pixel data we handle does not describe a Gaussian distribution. We have a more or less rectangular distribution to deal with. When using a regression technique we therefore will “over weight” pixels close to the border of a lamda/2 interval or the tm interval in the Y-case. A much better method to use is the more simple “area” estimation method. This method is also more accurate for this kind of data compared to the regression technique. To fit a line to an edge you just divide the database in two half's. In this case the data you have is x,y coordinates. You calculate the average value of all coordinates in each half. This way you will get two x,y points. These two points describes the line to be used in further calculations.

### Some Real Results

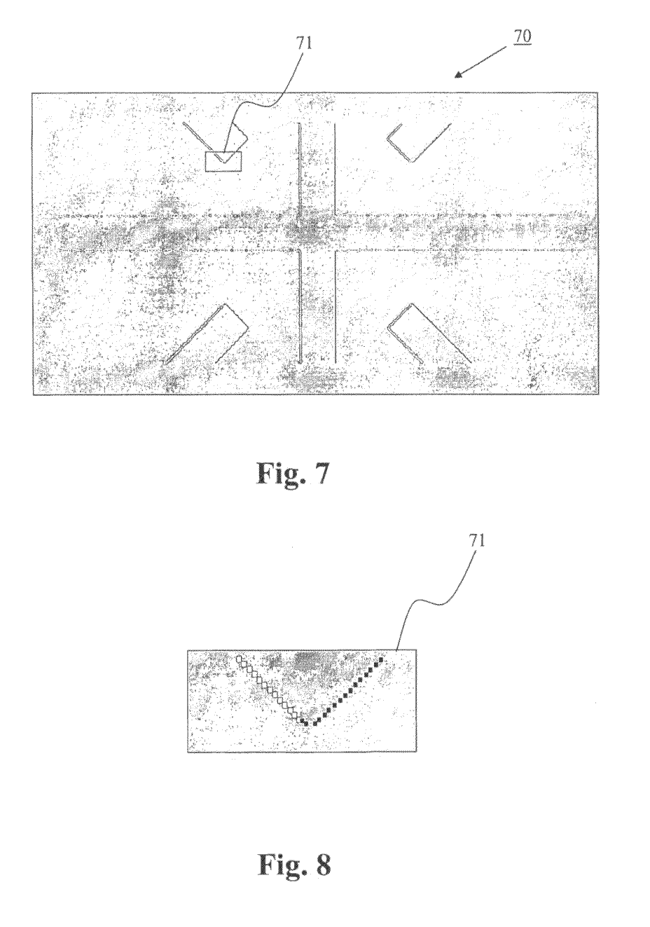

In FIG. 7 we have filtered the data using the above described algorithm. So far we have not applied any cursors. Only the average locations of the pixels have been calculated. The image 70 shown has been built from four runs over the mark.

The small square 71 in the image 70 is enlarged in FIG. 8. Here we have used the algorithm and some filtering in order to “sharpen up” the data. Each pixel in this image is a result of all four runs over the pattern.

### Cursors

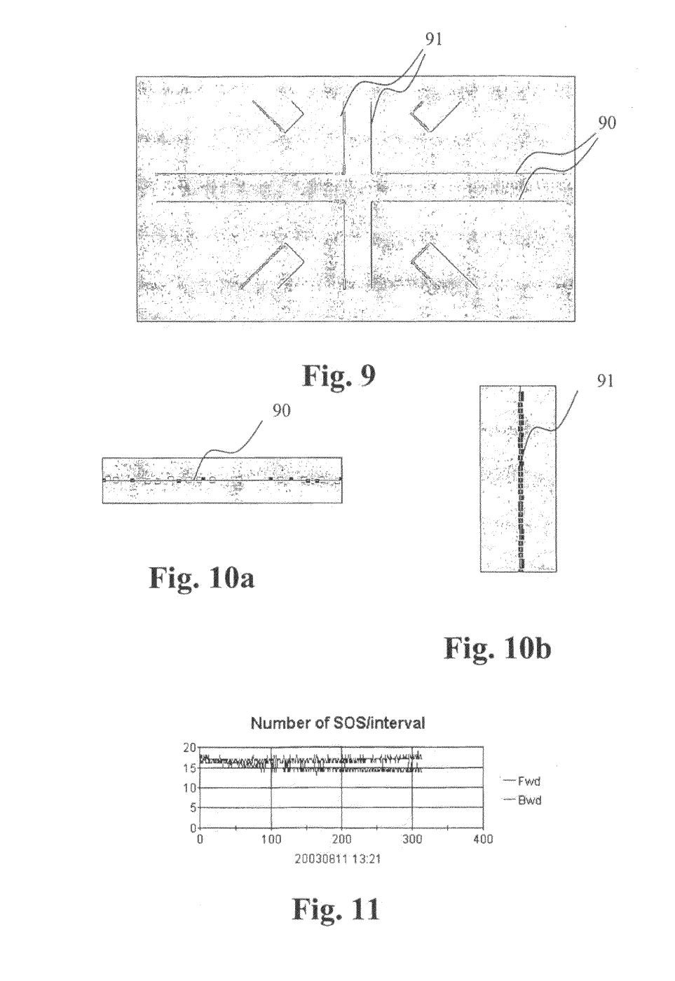

We now will apply cursors to the data in order to measure the CD and center of gravity position of the cross. The center of gravity of the cross is measured using four cursor pairs. These cursors are shown in FIG. 9.

Each line 90, 91 of the cursors is calculated based on the data from the edge in the cross. The line is calculated by using the simple “area” estimation method described above.

In FIGS. 10a and 10b, a part of an X and Y bar is expanded.

FIG. 10a shows a part of the upper left edge. The calculated cursor is an accurate estimation of the position of the edge in X-direction.

FIG. 10b is a part of the upper right edge of the cross. The position of this line 91 defines the edge position in Y-direction.

The reason for the mixture of white and black pixels along the Y-bar in FIG. 10a can be explained. The hardware has, in this example, a limitation in that it can only re-trig on an event after two clock periods of the measurement clock. This means that if we have a positive and negative transition inside this time period we will miss one of the events. This is one of the reasons that the pixels are a bit spread in Y-direction. Then because of the noise the hardware will trig randomly on a negative or positive transition. This is actually no problem due to the fact that if we have a positive or negative transition is not so important information. What counts is where the transition occurs. To know the “direction” of the edge we can use several transitions or other kinds of logic decisions to know which type of transition we have.

In below table the center of gravity and the CD is presented for the cursors. Below table shows the result of the four cursor pairs separately.

File: f_d_f_0602_105508.sd Hw cursor: 99.22 um

| | | | | | |
|---|---|---|---|---|---|
| X0(um) | Y0(um) | X1(um) | Y1(um) | Centre(um) | CD(um) |

Y-cursor 0

| | | | | | |
|---|---|---|---|---|---|
| 38.843 | — | 53.380 | — | 46.111 | 14.537 |

Y-cursor 1

| | | | | | |
|---|---|---|---|---|---|
| 53.348 | — | 38.789 | — | 46.069 | 14.558 |

X-cursor 2

| | | | | | |
|---|---|---|---|---|---|
| — | 100.648 | — | 115.106 | 107.877 | 14.458 |

X-cursor 3

| | | | | | |
|---|---|---|---|---|---|
| — | 100.690 | — | 115.128 | 107.909 | 14.439 |

The center position of the mark (Xcenter,Ycenter) may be calculated as the average value of the Y-cursor center values (Xcenter) and the X-cursor values (Ycenter).

### Second Order Effects.

So far we have discussed the main principles of the algorithm. We will now discuss two vital corrections that must be done on the data that are second order effects from the method.

First we need to correct for an eventual azimuth angle in the data. If we use a writer (as done in this case) we have a pre-misalignment between the X-movement direction and the ruler. This angle α can be expressed as:

$$α = a tan ( \frac{vx}{vy} )$$

Where vx is the exposure speed of the system and vy is the speed of the micro sweep.

This angle calculation can be reduced to the expression:

$$α = \frac{Number\_of \_beams}{Sos\_rate}$$

Where the Sos_rate is total number of pixel clock periods between two SOS. (See below for a more thorough explanation).

Another effect that must be taken care of is the effect of the X-movement during a measurement. Also here we will introduce an “azimuth” error. Even if we run the same number of positive strokes and negative strokes we will not cancel out this error completely. The reason is that this error has to do with the difference in speed for a positive and negative stroke. For a stroke in one direction we will therefore get an error that may be expressed as an angle (β).

This angle can be expressed as:

$$β = \frac{x Inc}{speed} \cdot \frac{1}{( Sos\_rate \cdot yPix )}$$

where xInc is lambda/2 [nm] and speed is total number of start of sweeps inside the xInc interval. If we divide β with a we will get a relation between the angles.

$$\frac{β}{α} = \frac{xInc}{speed} \cdot \frac{1}{( nbeans \cdot yPix )}$$

If we put in some realistic numbers, xInc=316 nm, Speed=8 Sos/interval, nbeams=9 beams and yPix=250 nm, we get:

$$\frac{β}{α} = \frac{316}{8} \cdot \frac{1}{( 9.250 )} = 0.0175$$

If we calculate the error generated by α on a distance of 100 um we will get:

alpha_error=100*9/1435=0.6272 μm. (The Sos_rate is taken from TFT3 system parameters). Since the β=0.0175*α we can calculate the error generated by the fact that we are moving during measurement to be:
0.0175*627.2[nm]=11 nm. This is a quite large error that cannot be neglected. This error will change sign depending of the direction of the measurement. If we measure during the same number of positive and negative strokes and the local speed is the same for both strokes this error will be cancelled out completely. In practice this is not the case. We will therefore get a small net-error due to this fact.

In the graph shown in FIG. 11, the average speed is presented for a measurement. 2 Forward strokes and 2 backward strokes were used. The hardware cursor was 99.22 um (314 lamda/2 intervals). As can be seen there is a significantly difference in local speed for the forward and backward stroke.

### Random Phase Measurement

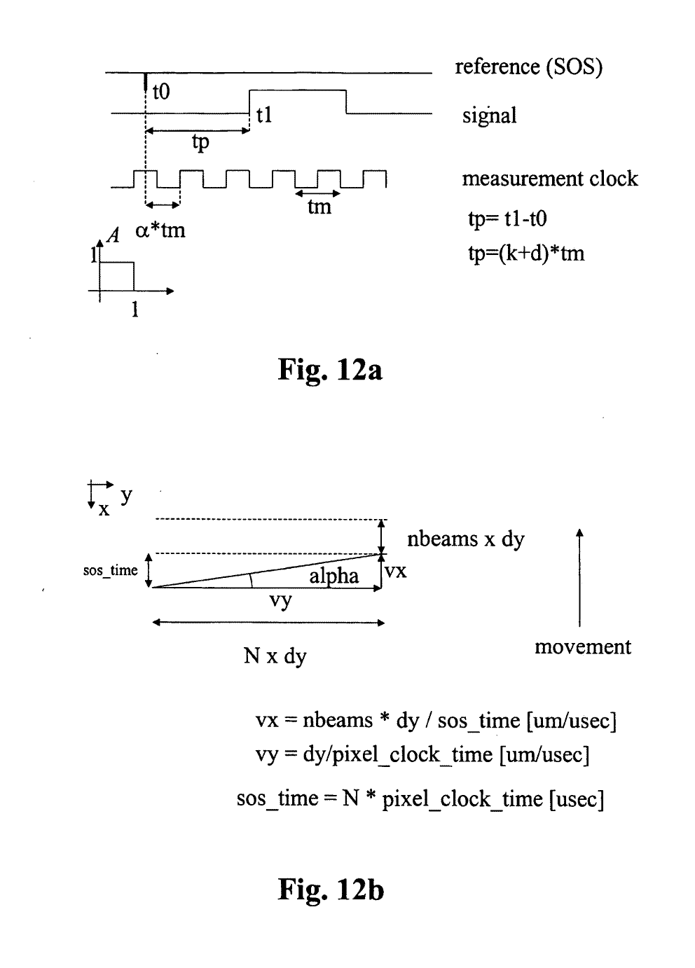

When using a random clock for measurement we shall see this as a statistical problem. In FIG. 12a the measurement situation is illustrated. What we want to measure is the time tp that is the difference between t1 and t0. The signal is synchronized with the reference signal.

We re-write the time tp as:

tp=(k+d)*tm

Where k is an integer number and d is the decimal part of tm. If we do this d will be a number in the interval [0, 1]. It will be shown later why this is a reasonable expression to use for tp.

We now introduce the measurement clock with a phase that is random relative the reference signal. We also introduce a counter that counts the positive going flanks of this clock. If we reset this counter with the reference signal we realize that we sometimes will count k flanks and some times k+1 flanks. No other counts are possible. We introduce the discrete stochastic variable K that in this way can get two values k and k+1.

We now look in FIG. 12a and introduce another stochastic variable, A which describes the phase of the clock relative the reference signal. A sample point of A (∝) will be a number in the interval [0, 1]. A is a continuous stochastic variable.

In FIG. 12a we can see the following important facts:
If ∝>d then the sample point of K will be k.
If ∝<d then the sample point of K will be k+1

What we now must do is to calculate to probability for the sample point k and k+1. To do this we must use the frequency function shown in FIG. 12a above. Since all phases have the same probability this is a rectangular distribution function.

We have:

$${P}_{k + 1} = {\int }_{0}^{d} F ( t ) d t = d , ( α < d )$$

$${P}_{k} = 1 - d , ( α > d )$$

So the probability that we get the sample point k+1 out from K will be d and the probability that we get the sample point k out of K is (1−d).

When we add the clock counts for each measurement and then divide with n we actually is estimating the average value for the stochastic variable K.

The estimated mean value may be expressed as:

$$E ( K ) = {\sum }_{- α}^{α} k \cdot p ( k )$$

Here we have only two possible sample points so we get:

E(K)=k·(1−d)+(k+1)·d=k+d

So when we rescale this result to nanoseconds we get

(k+d)·tm=tp.

This result proves that building the average value of the counter tics and scale this value with tm will give us the time we are after.

### The Sigma

To calculate the accuracy of the average value E(K) we need to find the variance of K.

The variance of a distribution may be expressed as:

$$V ( K ) = {\sum }_{- α}^{α} {( k - m )}^{2} \cdot p ( k ) \qquad ( 1 )$$

This can be re-written as:

V(K)=E(K)²+[E(K)]²

We get:

V(K)=k²·(1−d)+(1+k)²·d−(k+d)²=d·(1−d)

and

D(K)=sigma=\sqrt{d·(1−d)}

The variance function is actually very interesting. We see that if d=0, that means that we have no decimal part V(K)=0 we also see that if d is very close to 1, V(K)=0. Actually the variance has its maximum when d=0.5. In this case the variance is 0.25. The sigma will therefore be 0.5 as its maximum.

To interpret this you may think as follows. If d is 0 we always will count k ticks from the counter. Here we also assume that we count one tick if the positive going edge from the clock coincides with the reference signal. Since we always is counting k ticks independently of the phase of the measurement clock the spread also from the average value will be zero since variance is a measurement of the squared distance from the estimated average value. (Please refer to equation 1 above).

What is then the physical meaning of this?

Let us first make a practical example.

If we measure a signal with the decimal part 0.01 and k=2 the probability of counting a 3 in a measurement will be 0.01. This probability is the same for each measurement. Now if we calculate the average of 100 measurements we will probably add 99 samples of 2 and one sample of 3 (Case 1). But it is also possible that we add 100 samples of 2 and no samples of 3 (Case 2). The error we actually have in the average value is then:

$$\frac{0.1 \cdot ( 1 - 0.1 )}{\sqrt{100}} = \frac{0.09}{\sqrt{100}} = 0.009$$

So after 100 measurements in case 1 we will get:

$$\frac{99.2 + 1.3}{100} = \frac{201}{100} = 2.01 \pm 0.005 ,$$

and in case 2: 2.00+/−0.005

There is another very interesting way to see the physical conclusion of the case when d=0.

Assume that we want to measure a signal that is exactly k*tm. In this case the decimal part is zero. Now if we add counter ticks we must always count k ticks. Otherwise, and this is important, we should never get the correct average that is k in this case. In other words we cannot ever count k+1 ticks. If this would be the case the average we calculate would not be k. For this reasons the variance must be zero. Please note that only two numbers can generally be counted, k and k+1. So the value k−1 can never be counted. So in other words a count that is k+1 cannot be compensated by a value k−1 so we get the correct average anyway.

Since we do not know tp beforehand we should use the worst-case scenario when we estimate the error. In other words we shall say that the error due to the method is:

Error(K)=0.5*tm[ns].

This is as shown above the maximum of the function d*(1−d). If we want to use a symmetrical error instead we can express the method result as:

tp=((k+d)±0.25)·tm[ns]

The error in the method will go down if we use a large number of measurements. We can express the error as:

$$measurement\_error = \frac{1}{\sqrt{n}} \cdot 0.5 \cdot tm [ ns ]$$

This expression can be scaled to nanometers as:

$$Error ( nm ) = \frac{1}{\sqrt{n}} \cdot 0.5 \cdot rs [ nm ] ,$$

where rs is the actual resolution for the actual direction. If we put in some numbers, rs=291 nm in Y-direction and rs=40 (316/8) nm in X-direction. So the error in the estimation of a pixel position in X or Y direction may be approximated to be:

$${Y}_{Error} = \frac{1}{\sqrt{n}} \cdot 145 [ nm ]$$

$${X}_{Error} = \frac{1}{\sqrt{n}} \cdot 20 [ nm ]$$

### The Azimuth Angle

In FIG. 12b the exposure case is illustrated. Between two start of sweeps we moves the distance nbeams*dy [um] in X-direction. dy is the pixel size. We here assume a square pixel. In the same time we move N*dy [um] in Y direction.

The angle alpha (α) may be expressed as atan (vx/vy). If we calculate this angle we get:

$$α = a tan ( \frac{nbeams ⋆ d y / sos\_time}{d y / pixel\_clock \_time} )$$

The sos_time may be expressed as N*pixel_clock_time. N is here the total number of pixels between two start of sweeps. Finally we therefore can express the angle alpha (α) as:

$$α = a tan ( \frac{nbeams}{N} )$$

Please note that this angle is a constant “compensation” that preferably is removed from the database.

### Z-correction

The described method for determining coordinates of an arbitrarily shaped pattern on a surface in a deflector system assumes that the surface is planar, which, however, is not the actual case. Small variations in height in the z direction, i.e. perpendicular to the X-Y plane, occur on all surfaces as is disclosed in the not published International patent application PCT/SE2004/001270, filed 3 Sep. 2004, by the same applicant, which is hereby incorporated as reference. The method for determining an arbitrarily shaped pattern on a surface is preferably combined with the method for determine a correction function which compensate for the variations in height H_{Z}.

An essential part of the invention is to determine a reference surface against which the difference in height H_{Z} is calculated. This difference is denoted H, as is illustrated in connection with FIG. 13. The reference surface could have any desired shape as long as the shape of the reference surface is maintained unchanged. Preferably, the shape of the reference surface is a flat plane.

If it were possible, it may have been desirable to use the “free” (non gravity) form, i.e. the centre line of the plate as a reference surface, which is rather difficult to achieve in practice. The bottom surface of the plate is not a good alternative for a reference surface since a stepper or an aligner use the top surface as a reference.

On the other hand if the top surface would be used as a reference surface, there is an additional need to know the bottom shape of the plate and the shape of the support. The shape of the support may be obtained, but it is very difficult to achieve knowledge of the bottom surface in practice. The top surface may however be measured without the knowledge of the bottom surface. A large glass plate that is placed on a three-foot will be deformed due to the weight of the plate, but a deformation function for a perfect plate may be calculated if the thickness of the plate, the material of the plate and the configuration of the three-foot are known. A measurement of the non-perfect glass plate, when placed on the three-foot, will generate a measurement of the deformed plate. The shape of top surface is then calculated by subtraction the calculated deformation function for a perfect plate from the measurement of the deformed plate.

The top surface of a glass plate is normally much more even, i.e. less variation in height in relation to the centre line, compared to the bottom surface, and the best compromise should therefore be to make the top surface of the plate to be the reference surface. It should however be noted that it is not evident that the top surface is the best choice due to the deformation of the glass plate during the following step in an exposure system. If the top surface 113 of the glass plate exhibits variations close to the position where it rests on a support, the pattern on the surface 113 will be distorted in a vicinity of the support.

It should however be noted that any surface may be used as reference surface, although the top side is preferred.

FIG. 13 illustrates the plate bending effect for a glass plate 111 having a thickness T. A reference surface 130 is determined, in this example the reference surface is flat, and the glass plate is divided into several measurement points 131 and the height H_{Z} is measured at each measurement point by means known from the prior art. The height H between the reference plane 130 and the deformed surface 113 of the glass plate 111 can easily be calculated by subtracting the height of the reference surface 130 at the measurement point from the height H_{Z} measured for the surface 113 of the glass plate 111 by the apparatus.

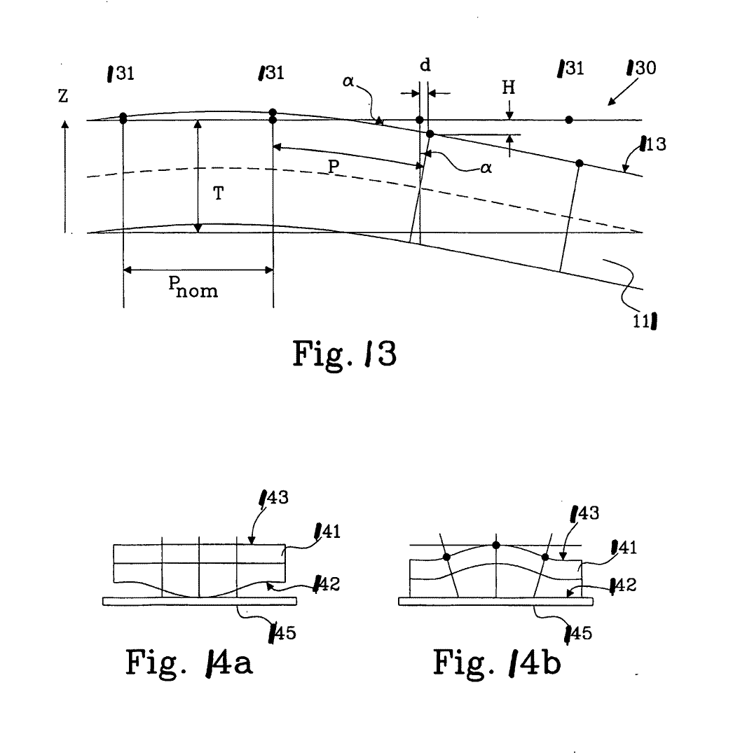

A local offset d (as a function of x and y) is thereafter calculated for each measurement point and depends on three variables: the thickness of the glass plate (T), the distance between adjacent measurement points (P) and the measured height (H) between the reference surface 130 and the surface 113 of the glass plate 111. The local offset should be interpreted as the position deviation from the position where a pattern should be written in relationship to the reference surface, as described in connection with FIGS. 14-16. The pitch P on the surface of the plate differs from the nominal pitch Pₙₒₘ on the reference surface.

The distance between adjacent measurement points should not exceed a predetermined distance, which is dependent on the required accuracy for the measurement to get a reasonable good result from the measurement. An example of maximum distance between adjacent measurement points is 50 mm if the thickness of the glass plate 111 is around 10 mm and the glass plate material is quartz. The distance between adjacent measurement points also vary dependent on the thickness of the glass plate to obtain the same measurement accuracy. The variations in thickness of the glass plate is may be around 10-15 μm, but could be larger. The measurement points could be randomly distributed across the surface 113, but are preferably arranged in a grid structure with a predetermined distance between each point, i.e. pitch, that is not necessarily the same in the x and y direction.

The local offset is a function of the gradient in x and y direction at each measurement point and could be calculated using very simple expressions.

An angle α may be calculated from the measured height H provided the distance P between two adjacent measurement points 131 is known.

For small angles α:

$$α = \frac{H}{P}$$

Furthermore the local offset d may be calculated provided α is small using the formula:

$$d = \frac{T}{2} ⋆ α = \frac{H ⋆ T}{2 ⋆ P}$$

It should however be noted that the formula for calculating the local offset d above, only is a non-limiting example of a calculation to determine the offset d. The gradient in each measurement point could be directly measured by the system and the local offset is proportional to the gradient and the thickness of the plate.

As previously mentioned above, FIG. 13 illustrates the bending effect in one dimension, but the local offset d is a 2-dimensional function of the derivative in each measurement point (dx and dy).

As a non-limiting example we assume that the distance between two adjacent points 131 is 40 mm, the thickness of the glass plate is 10 mm, and that the measured height H is 1 μm, which will result in a one-dimensional local offset d of 125 nm.

FIGS. 14a and 14b illustrate the plate bending effect a glass plate 141 with a flat top surface 143 and a shaped bottom surface 142 and the introduction of a reference surface 144, which is flat in this example, when supported by a flat support 145.

When the glass plate 141 is arranged on the flat support 145, the shape of the top surface 143 is changed and the bottom surface 142 will generally follow the flat support 145. The result of this is that the pattern generated, illustrated by the dots 146 on the top surface, has to be expanded to obtain a correct reference surface.

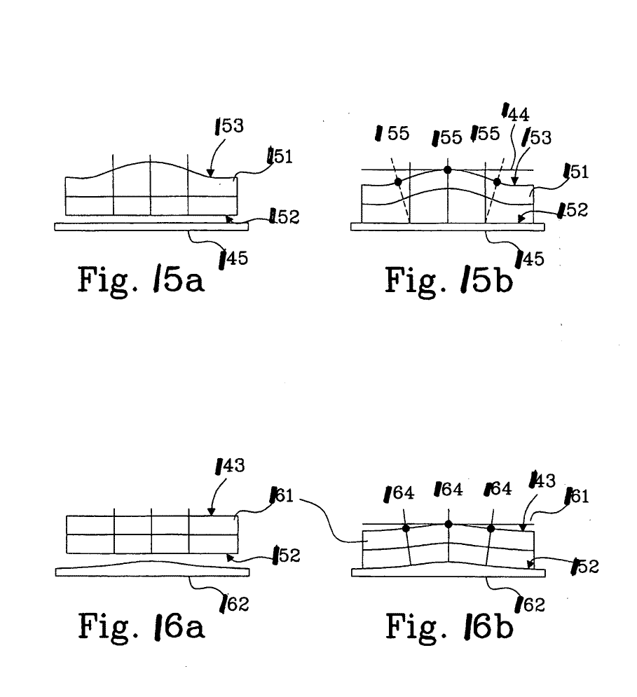

FIGS. 15a and 15b illustrate the plate bending effect a glass plate 151 with a shaped top surface 153 and a flat bottom surface 152 and the introduction of a reference surface 144, which is flat in this example, when arranged on a flat support 145.

When the glass plate 151 is arranged on the flat support 145, the shape of the top surface 143 is unchanged and the bottom surface 142 will follow the flat support 145. The pattern generated, illustrated by the dots 155 on the top surface, has to be expanded to obtain a correct reference surface, since the top surface will be flattened out when positioned in a typical exposure equipment known in the prior art, at least in the vicinity of the support. The part of the glass plate positioned right between the supports will be deformed. Furthermore the support will deform the pattern on the glass plate unless the shape of the support is in accordance with the shape of the reference surface.

FIGS. 16a and 16b illustrate the plate bending effect a glass plate 161 with a flat top surface 143 and a flat bottom surface 152 and the introduction of a reference surface 144, which is flat in this example, when arranged on a shaped support 162.

When the glass plate 161 is arranged on the shaped support 162, the shape of the top surface 143 is changed and the bottom surface 142 will generally follow the shaped support 162. The pattern generated, illustrated by the dots 164 on the top surface, has to be expanded to obtain a correct reference surface, since the top surface will be flattened out when positioned in an exposure equipment.

FIGS. 14a-14b, 15a-15b and 16a-16b illustrate extreme conditions and in reality all three variations are present during the process of writing a pattern on a glass plate.

The overall error is however much smaller since all errors from the bottom surface, support surface and contamination are eliminated or at least reduced.

Although a glass plate has been used as an illustrative example in the patent application, the scope of the claims should not be limited to a plate made of glass.

The process of determining the suitable correction function for a surface of an object could be performed before, during or even after the process of determining the coordinates of an arbitrary shaped pattern on a surface is performed, wherein the object is used for determining the position of a mark on the object for calibration purposes. The correction function will enhance the accuracy of the measurement and thus improve the calibration process.

1. A method for determining the coordinates of an arbitrarily shaped pattern on a surface in a deflector system, wherein the method comprises the steps of:
a) selecting a reference clock signal (lambda/2) that defines a movement in a first direction (X),
b) providing a micro sweep that repeatedly scans the surface in a second direction (Y), perpendicular to the first direction (X),
c) selecting a measurement clock signal (SOS) that is related to the signal used to start each micro sweep in the second direction (Y),
d) adjusting the speed of the movement in the first direction (X) to determine the distance between the start of each micro sweep,
e) performing a first run that include the steps of:
e1) starting a first micro sweep at a starting position,
e2) detecting at least one edge of the arbitrarily shaped pattern when the pattern is moved in the first direction (X) relative the deflector system,
e3) generating at least one event if the edge of the pattern is detected, and
e4) counting the number of micro sweeps performed until each event is generated,
f) calculating the coordinate of the edge, for each event, in the first direction (X) using the number of performed micro sweeps,
g) determining a correction function for the surface, either before, during or after the steps a)-f) have been performed, to establish a 2-dimensional local offset (d) in the x-y plane for measurement points on the surface to compensate for variations in a third direction (Z), perpendicular to the first direction (X) and the second direction (Y), and
h) calculating the coordinates of the arbitrarily shaped pattern using the determined correction function.

2. The method according to claim 1, wherein more than one run as defined in step e) is performed and for each run the starting position in step e1) is randomly selected, thereby generating randomly distributed micro sweeps between each run.

3. The method according to claim 2, wherein an average value of the edge is calculated in step f) to increase the accuracy of the patterns coordinate in the first direction.

4. The method according to claim 1, wherein said the selected reference signal in step a) contains the known position of the system in the first direction (X).

5. The method according to claim 4, wherein said selected reference signal in step a) is divided into intervals, where each interval preferably corresponds to a lambda/2 period, and the selected measurement clock signal in step c) have a period that corresponds to 8-10 scans of the pattern in each interval.

6. The method according to claim 1, wherein the method comprises a compensation for an azimuth error introduced when the micro sweep scans the surface in the second direction (Y) during movement of the surface in the first direction (X).

7. The method according to claim 6, wherein said compensation is a constant compensation.

8. The method according to claim 1, wherein the determination of coordinates of the arbitrarily shaped pattern also includes the determination of the coordinate in the second direction (Y) using as a reference signal: the signal used to start each micro sweep in the second direction, and as a measurement signal: a pixel clock signal.

9. The method according to claim 1, wherein said method is adapted to be used in a laser lithography system or an e-beam lithography system.

10. The method according to claim 1, wherein the determined correction function in step g) includes measuring of the physical properties of the surface, comprising the steps of:
arranging the object having a thickness (T) provided with the surface on a stage of a measuring apparatus,
dividing the surface of the object into a number of measurement point, where two adjacent measurement points being spaced a distance apart not exceeding a predetermined maximum distance,
determining the gradient of the surface at each measurement point,
calculating the 2-dimensional local offset (d) in the x-y plane for each measurement point as a function of the gradient, and the thickness (T) of object, and
determining a correction function for the surface using the calculated 2-dimensional local offset (d) for each measurement point.

11. The method according to claim 12, wherein the step of determining the gradient comprises measuring the variation in height of the surface at each measurement point.

12. The method according to claim 11, wherein the step of measuring the variations in height of the surface comprises the steps of:
determining a reference surface,
measuring the height (H) between the reference surface and the surface of the object at each measurement point,
whereby the 2-dimensional local offset (d) in the x-y plane may be calculated as a function of the measured height (H), the distance (P) from each at least one adjacent measurement point, and the thickness (T) of the object.

13. The method according to claim 10, wherein the object is a reference object, and said surface is provided with marks at each measurement point.

14. A method for determining the coordinates of an arbitrarily shaped pattern in a deflector system, wherein the method comprises the steps of: moving the pattern in a first direction (X), calculating the position of the edge of the pattern by counting the number of micro sweeps, performed in a perpendicular direction (Y), until the edge is detected, determining a correction function for the surface reflecting variations in a third direction (Z) perpendicular to both the first (X) and the second (Y) directions, and determining the coordinates by relating the number of counted micro sweeps to the speed of the movement of the pattern using the correction function to compensate for variations in the third direction.

15. The method according to claim 14, wherein the speed of movement of the pattern is correlated with the number of micro sweeps performed.

16. The method according to claim 14, wherein the pattern is scanned several times, so called runs, and an off-set in the first direction (X) for the first micro sweep is randomly selected for each run.

17. The method according to claim 16, wherein the position of the edge is obtained from an average value from all runs.

18. The method according to claim 14, wherein the determined correction function includes measuring of the physical properties of the surface of the object having a thickness (T), comprising the steps of:
determining a gradient of the surface at defined measurement points,
calculating the 2-dimensional local offset (d) in the x-y plane for each measurement point as a function of the gradient, and the thickness (T) of object, and
determining a correction function for the surface using the calculated 2-dimensional local offset (d) for each measurement point.

19. The method according to claim 18, wherein the step of determining the gradient comprises measuring the variation in height of the surface at each measurement point.

20. The method according to claim 19, wherein the step of measuring the variations in height of the surface comprises the steps of:
determining a reference surface,
measuring the height (H) between the reference surface and the surface of the object at each measurement point,
whereby the 2-dimensional local offset (d) in the x-y plane may be calculated as a function of the measured height (H), the distance (P) from each at least one adjacent measurement point, and the thickness (T) of the object.

21. The method according to claim 18, wherein the object is a reference object, and said surface is provided with marks at each measurement point.

22. Software used in a deflector system for determining the coordinates of an arbitrarily shaped pattern in a deflector system, wherein the software facilitate the execution of the method as defined in claim 1.
